(19) United States
(12) Patent Application Publication
(10) Pub. No.: US 2013/0133274 A1
(43) Pub. Date: May 30, 2013

(54) TRANSPARENT WALL, GREENHOUSE, WINDOW, FACADE, AND ROOF

(71) Applicant: Kurt Blessing, Ludenscheid (DE)

(72) Inventor: Kurt Blessing, Ludenscheid (DE)

(73) Assignee: LUXeXcel Holding BV., NC Wolphaartsdijk (NL)

(21) Appl. No.: 13/637,455

(22) PCT Filed: Mar. 30, 2011
(86) PCT No.: PCT/EP2011/001594

§ 371 Date: Sep. 26, 2012

(30) Foreign Application Priority Data
Apr. 1, 2010 (DE) 10 2010 013 858.4

(51) Int. Cl. F21V 33/00; E04B 7/00; E04B 2/00

(52) U.S. Cl. CPC F21V 33/006; E04B 2/00; E04B 7/00
USPC 52/171.3

(57) ABSTRACT

The invention relates to a transparent wall, comprising at least one transparent wall substrate having a light-guiding structure, wherein the light-guiding structure is imprinted directly or indirectly on the wall substrate.

### PRIOR ART

The invention proceeds from a transparent wail comprising at least one transparent wall substrate that is provided with a light-guiding structure.

Such transparent fells are generally known. For example, windows with glass substrates are known into which light-guiding structures are impressed in order to attain specific optical effects. However, it is disadvantageous that such pressing methods are very complicated and cost-intensive.

### DISCLOSURE OF THE INVENTION

The object of the present indention is therefore to provide a transparent wail of the abovenamed type that can, by comparison with the prior art, be produced greatly more cost-effectively, more quickly, more accurately and more flexibly.

This object is achieved by a transparent wall that comprises at least one transparent wall substrate that is provided with a light-guiding structure, the light-guiding structure being indirectly or directly printed onto the wall substrate.

It has emerged surprisingly and unpredictively for the person skilled in the art that the light-guiding structure can be printed onto the wall substrate directly or indirectly such that the light-guiding structure can be produced on the wall substrate in a way that is comparatively cost-effective. The light-guiding structure is preferably printed directly onto the transparent wall substrate, which preferably comprises glass and/or plastic. Alternatively, however, it is also conceivable far the light-guiding structure firstly to be printed onto a film that is subsequently applied, and in particular glued, to the wall substrate. The printing method preferably comprises an inkjet printing method, the light-guiding structure being, in particular, built up by means of a multiplicity of droplets that are, for example, deposited on the wall substrate or the film, using a DOD (Drop-On-Demand) method and are subsequently cured by means of UV irradiation.

The light-guiding structure preferably takes the form of a prism, Fresnel lens, converging fens and/or diverging lens, by means of which light beams incident on the transparent wall and/or traversing the transparent wall are deflected and/or reflected in a desired way. The respective deflection or the desired degree of reflection is controlled in this case by an appropriate selection of the geometry of the light-guiding structure. In addition, it is preferably possible to set an appropriate wavelength dependence of the degrees of deflection or reflection.

A further subject matter of the present invention is a greenhouse that has a transparent wall of this type. Parts of the greenhouse such as walls, windows, doors and/or roofs, or the entire greenhouse preferably consist or consists of such transparent walls. In preferred embodiment, it is conceivable for the light-guiding structures to be designed as a function of the plants to be raised in the greenhouse so that the plants are, for example, supplied chiefly with light beams of a desired wavelength region and/or from a specific direction. Furthermore, it is conceivable that incident light can traverse the transparent wall virtually without interference, whereas light beams that fall onto the transparent wall from the interior of the greenhouse are totally reflected back into the interior so as to attain heating up of the greenhouse (greenhouse effect). The transparent wall preferably comprises a double glazing composed of two wall substrates, the light-guiding structure being arranged on one of the two wall substrates between the two wall substrates.

An embodiment of the indention that is to be considered purely as an example is described below with reference to the attached drawings.

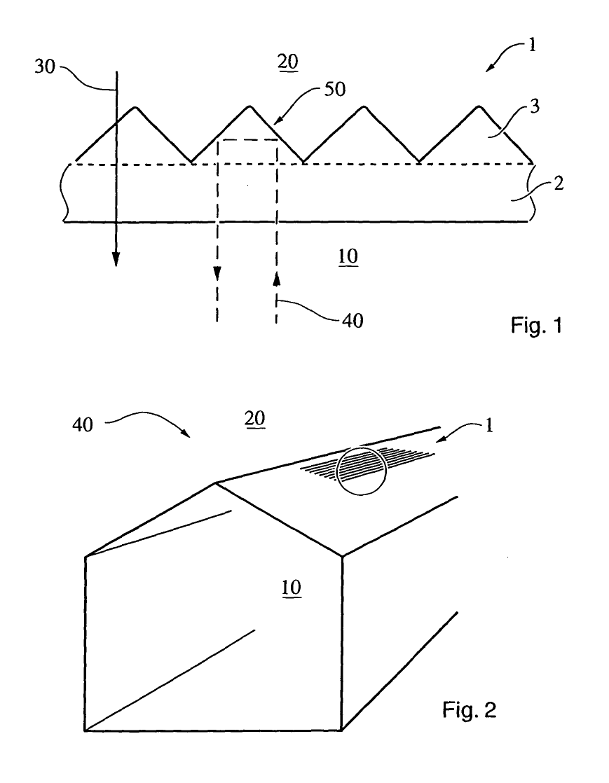

A schematic sectional view of a transparent wall 1 that separates a first region 10 from a second region 20 is illustrated for example in FIG. 1. The transparent wall 1 comprises a wall substrate 2 made from glass. A light-guiding structure 3 is printed onto the wall substrate 2 by using an inkjet printing method. The light-guiding structure 3 comprises a prismatic structure which is designed in such a way that light beams 30 emanating from the second region 20 can traverse the light-guiding structure 3 from the second region 20 in the direction of first region 10 virtually without interference, while light beams 40 emanating from the first region 10 experience a total reflection 50 through dual reflection at the prismatic structure and are guided back in the direction of the first region 10.

A schematic of a greenhouse 60 is shown for example in FIG. 2, at least the roof of the greenhouse being provided with the transparent wall 1 shown in FIG. 1. The interior of the greenhouse 60 in this case forms the first region 10, while the outer surroundings of the greenhouse 60 form the second region 20. The light-guiding structures consist in this case of, in particular, a multiplicity of elements, each element consisting of a multiplicity of droplets that are deposited on the wall substrate with a plane boundary surface, and whose approximately hemispherical curvature projects from the substrate, the droplets having different diameters, and the droplets consisting of a transparent material.

The optical microstructures formed can have a light-guiding or antiglare effect by deflecting incident daylight so that a viewer cannot look into the main beam path. An antiglare optical effect can be achieved by applying these light-guiding structures in the area of a façade, window or door. The result here is a sunscreen in conjunction with high transparency. This is achieved, in particular, owing to the fact that the total effect of the device constitutes a prism that deflects the light from the main observation direction to the side or upwards.

The optical microstructures formed can, alternatively, also have a cooling effect by deflecting incident daylight so that the light is largely reflected outward copending on the incidence angle, and can penetrate into the interior only to a small extent (in this case, the first and second regions 10, 20 being, in particular, interchanged). Combinations of the individual optical effect a are also conceivable.

A further example of application (not illustrated) of the inventive transparent wall with a light-guiding structure in the form of a converging lens is the use of daylight for plant illumination. In this case, the light-guiding structures can be formed on windows, conservatories or greenhouses in such a way that, for example, exotic plants requiring a large amount of light and heat are targeted for irradiation. A further conceivable use is to utilise daylight or artificial room light to illuminate plants, vitrines and shelves. Here, light-guiding structures can be printed and aligned on the topside of the furniture, or on the inside of a greenhouse so that plants, goods or exhibits situated therein are targeted for irradiation. Panes having the inventive device can be printed, for example, on so-called flatbed printers.

Furthermore, it is, for example, conceivable to arrange a plurality of transparent ink drops of different or the same size next to one another such that together they have a local effect of targeted refraction of light. This array can be formed as often as desired by multiple deposition of ink drops on the same site in a y-axis. The array is supplemented by a multiplicity of further arrays to form a matrix that combines the individual optical effect of each array into a total optical structure. The partial structure is therefore not linear, as with Fresnel lenses, but constitutes a matrix. The total design therefore does not correspond to an undefined optical effect such as, for example, the scattering effect of a screening pane made from structured Plexiglass, or the backlighting of displays, but what is desired here is targeted magnification or demagnification. The production of an inventive transparent wall with light-guiding structures printed on is performed firstly by prescribing and calculating the desired optical effect, for example in terms of size, focal length, angle of deflection, etc. The geometric data of the optics on the y-axis are then transferred onto a plane. Here, these data are arranged in a matrix so that individual arrays are defined corresponding to the resolution and the ink drop size. These data are now vectorized via a software, and transferred onto the known color representation in the CMYK system. That is to say, any desired function is now assigned a color from the CMYK system of the printer software by taking account of the position, for example the variation of the ink drop size, or by multiple deposition of ink drops at one location.

Since a modern printer includes several printing heads, a combination of printing colors and ink drop sizes can be achieved by selecting the printing heads. Particular preference is given here to printing heads that can produce very small drops in the range of 1 picoliter. Particular preference is given here to printing heads that process clear transparent ink. However, in order to produce optical images, it is also possible to desire a combination in equipping the printer with various printing heads for various colors and clear lacquer.

UV-light-curing inks are preferred in order to achieve very fast curing. The curing, is performed here via UV lamps. For this specific object, it is preferred to use UV lamps that are positioned directly at the printing heads. Furthermore, it is particularly advantageous when these UV lamps, whether individually or as an entire unit, have a narrowly focused emission characteristic. Owing to the short distance and compact spatial arrangement, it is possible thereby for the ink drop just deposited to be irradiated directly with the UV radiation and be cured very quickly without running. Furthermore, it is particularly advantageous when the UV lamps are driven electrically so that they light up only at the moment when the ink drop strikes the substrate. This can be performed offset in time by a parallel signal of the ink drop production. It would be possible thereby to reduce the consumption of energy and chemical emission. The UV clear lacquer can still be flexible or hard in the cured state depending on application and substrate.

The angles of the individual prisms can be designed as required. If, for example, they are 45°, the light is refracted and scattered in two directions in one irradiation direction; however, in the other irradiation direction the light is totally reflected twice. This gives rise to a reflective property.

1. A transparent wall comprising:
at least one transparent wall substrate that is provided with a light-guiding structure,
wherein the light-guiding structure is indirectly or directly printed onto the wall substrate.

2. The transparent wall as claimed in claim 1,
wherein wall substrate is coated with a coating onto which the light-guiding structure is directly printed.

3. The transparent wall as claimed in claim 1, wherein the light-guiding structure comprises a prismatic structure and a diverging and/or converging lens designed as a Fresnel lens.

4. The transparent wall as claimed in claim 1, wherein the transparent wall is provided to separate a first region from a second region along a direction perpendicular to the main plane of extent of the transparent wall.

5. The transparent wall as claimed in claim 4, wherein the prismatic structure is designed so that light beams incident, perpendicular to the transparent wall from the first region are totally reflected, by respective twofold reflection on the prismatic structure.

6. The transparent wall as claimed in claim 4, wherein the prismatic structure is designed so that light incident, perpendicular to the transparent wall from the first region are substantially deflected by a predetermined angle.

7. The transparent wall as claimed in claim 1 wherein the prismatic structure is designed in such away that the total reflection and/or deflection is performed as a function of the wavelength of the light beams.

8. The transparent wall as claimed in claim 5, wherein the prismatic structure is designed so that light beams incident, perpendicular to the transparent wall from the second region substantially traverse the transparent wall without interference.

9. The transparent wall as claimed in claim 1, wherein the wall substrate comprises:
a glass and/or a transparent plastic, and/or the light-guiding structure comprises a transparent polymer that is applied to the wall substrate and/or the film fey means of an inkjet printing method.

10. The transparent wall as claimed in claim 1, wherein the transparent wall comprises two wall substrates, the light-guiding structure being arranged between the two wail substrates, and the space between the two wall substrates being evacuated.

11. The transparent wall as claimed in claim 1, wherein the transparent wall is part of a house, greenhouse, wall, door, window, vitrine, furniture, aquarium, terrarium or the like.

12. A greenhouse having a transparent wall as claimed in claim 1.

13. A window having a transparent wall as claimed in claim 1.

14. A façade having a transparent wall as claimed in claim 1.

15. A roof having a transparent wall as claimed in claim 1.

16. The transparent wall as claimed in claim 2, wherein the light-guiding structure comprises a prismatic structure and, a diverging and/or converging tens designed as a Fresnel lens.

17. The transparent wall as claimed in claim 16, wherein the transparent wall is provided to separate a first region from a second region along a direction perpendicular to the main plane of extent of the transparent wait.

18. The transparent wall as claimed in claim 17, wherein the wall substrate comprises:
a glass and/or a transparent plastic, and/or the light-guiding structure comprises a transparent polymer that is applied to the wail substrate and/or the film by means of an inkjet printing method.

19. The transparent wall as claimed in claim 18, wherein the transparent wall comprises two wall substrates, the light-guiding structure being arranged, between the two wall substrates, and the space between the two wall substrates being evacuated.

20. The transparent wall as claimed in claim 19, wherein the transparent wall is part of a house, greenhouse, wall, door, window, vitrine, furniture, aquarium, terrarium or the like.
